(19) United States
(12) Patent Application Publication
(10) Pub. No.: US 2008/0232811 A1
(43) Pub. Date: Sep. 25, 2008

(54) Infrared remote control system and method

(75) Inventors: Ronald E. Milner, Grass Valley, CA (US); Benjamin D. Milner, Grass Valley, CA (US)

Correspondence Address: NATH & ASSOCIATES, 112 South West Street, Alexandria, VA, 22314, US

(73) Assignee: ROKENBOK TOY COMPANY, Solana Beach, CA (US)

(21) Appl. No.: 12/073,933

(22) Filed: Mar. 12, 2008

Related U.S. Application Data
(60) Provisional application No. 60/918,851, filed on Mar. 20, 2007.

(51) Int. Cl. H04B 10/00

(52) U.S. Cl. 398/112

(57) ABSTRACT

Disclosed is a remote control device for causing operation of a function on at least one of a plurality of different remotely controlled devices. The device includes a randomizer that determines a random local address for the remote control device. The device also includes a modulated optical transmitter that emits a signal containing the random local address. Reception of the random local address by one of the remotely controlled devices establishes a communication link between the remote control device and that particular remotely controlled device. After communication has been established the modulated device, through any of a plurality of optical transmitters, dictates the actions of the remotely controlled device.

This application claims the benefit of provisional application No. 60/918,851, which was filed on Mar. 15, 2007.

### FIELD OF THE INVENTION

The subject matter disclosed herein relates to remote controls and remotely controlled devices.

### BACKGROUND

Prior art remote control systems rely on fixed addresses being assigned to each vehicle either by jumpers, switches, different “keys,” or by special modes selectable at the vehicle to accept a new address broadcast by a handheld controller. Further, prior art remote control systems have often relied on radio frequency transmission to the exclusion of infrared transmission to provide communication between a controller and a controlled device.

Israeli Patent No. 6546436 discloses a system based on a PC as a programmer/transmitter for a fleet of toys. A programmer can define an ID code for each toy, network of toys, and time sharing.

U.S. Pat. No. 4,334,221 has the basics of a sparse time control system used to control multiple vehicles with multiple transmitters; however, it is an RF system. This reference is directed toward control of several vehicles by several controllers. U.S. Pat. No. 6,661,351 discloses using two bit IDs to radio RC cars. This reference discloses user changeable ID with an indicator on the vehicle to show which of the IDs a user has changed to. This patent is limited to radio. Lionel Trains' TMCC system [Trainmaster Command Control] is described in various documents such as http://www.lionel.com/Products/Findex.cfm. This system is configured such that a switch on the vehicle is actuated to make the vehicle accept an address that is manually entered in by a handheld controller.

### SUMMARY

The present system allows a child to point a handheld remote controller (alternatively referred to herein as a “remote control device” and a “controller”) at any random vehicle that he wants to control and press a button to gain such control. The child is then in control of that vehicle with the remote controller. There is no knowledge to the user of addresses or codes for the vehicle to be controlled. The present system is completely intuitive due to the system's “point and shoot” nature.

U.S. Patent Application Publication No. 2005/0110653 discloses a control system for toy trains with a two way communication between the train and the controller to give the handheld controller the train's preset address. Contrastingly, the present inventive system only requires one way communication that is in place for the normal control using a single receiver module on the vehicle.

The remote control device includes a button (alternatively referred to herein as the “Hey You” button) for taking control of a remotely controlled device and a randomizer that is activated when the Hey You button is pressed. The randomizer determines a random address for the remote control device. The remote control device also includes a modulated optical transmitter that emits an infrared signal containing the random address and a command word indicating that this is a new address. Reception of the random address by one of the remotely controlled devices accompanied by the new address command word causes the remote control device to store the random address and establishes the address for successive commands between the remote control device and that particular remotely controlled device. After communication has been established, the remote control device, through a second optical transmitter, dictates the motion of the remotely controlled device.

The device can be subjected to several variations such as when the modulated optical transmitter emits the random address to at least two different remote controlled devices thereby simultaneously controlling both devices. Also, control of the remotely controlled device is generally limited to a single controller but the remotely controlled device could be made to respond to two or more separate controllers by for instance including a reserved address that is an “all vehicles” address.

In the disclosed embodiments, the signal is an infrared signal. However, the subject matter is not limited to infrared; the signal can be any other signal that is capable of modulation or embedding with coded instructions. The transmission time for a signal from the remote control device to the remotely controlled device in one embodiment is between 6 ms and 9 ms using 56 khz modulation. The signal includes bits for address, commands and a checksum to be sure the signal has been received correctly and to reject signals that might come in due to random noise.

A method of causing a function of a remotely controlled device includes pointing a remote control device in the direction of the remotely controlled device; actuating an actuator (the “Hey You” button) on the remote control device thereby causing the device to send a remote device address to a signal receiver on the remotely controlled device; and then emitting encoded signals from an infrared signal emitter on the remote control device so as to dictate motion of the remotely controlled device. To simultaneously control a second device, a user must aim and press the “hey you” button at the second vehicle within two seconds of the first time the “hey you” button was pressed. The controller firmware will repeat the same address for two seconds in case the command didn't get through the first time. This can be taken advantage of to “capture” a second vehicle if desired. Thus, a user can even give three or more vehicles the same address to move together.

The remote control can also be used to toggle between two vehicles. A button is provided on the remote control that will switch back and forth between the current address and the previous address, thus allowing control of either the present or the previously addressed vehicle.

### BRIEF DESCRIPTION OF THE DRAWINGS

FIG. 1 shows a remote controller and a remotely controlled device;

FIG. 2 shows three remote controllers, each with a corresponding remotely controlled device;

FIG. 3 is a diagram showing a layout of a packet used in communication between the remote controller and the remotely controlled device;

FIG. 4a is a block diagram of the remote controller

FIG. 4b is a block diagram of the remotely controlled device;

FIG. 5a is a first chart showing a modulated signal as a function of time that can indicate a logical 0; and

FIG. 5b is a second chart showing a modulated signal as a function of time that can indicate a logical 1.

### DETAILED DESCRIPTION

With reference to FIG. 1, a handheld wireless remote controller 2 with several buttons 4a, 4b, 4c, 4d and 4e and an internal microprocessor (not shown) transmits modulated infrared (IR) signals from a narrow beam modulated optical transmitter 6 or a wide beam optical transmitter 40 to an IR receiver 8 on a vehicle 10. On the vehicle 10, a microprocessor decodes the signals, checks for correctness including matching the remote controller's address and checksum and operates the motors, lights, and speaker in the vehicle 10.

The controller 2 assigns an address to a particular vehicle as follows: a button 12 on the controller 2, which may be labelled “Hey You,” is pressed. One will easily recognize, though that it is not necessary to label a button as “Hey You” in order to practice the present subject matter. A randomizer within the controller 2 generates a random address for the controller 2. The address is stored in the controller 2 as long as the controller 2 has power from its batteries. The controller 2 sends out a command including the address and a data field command (the Hey You command) and checksum to set the address in the vehicle 10, preferably by a narrow beam of visible light or modulated IR that can be directed to the vehicle 10 or to any other vehicle by pointing the modulated optical transmitter 6 at that vehicle. Controller 2 preferably includes a small telescope to focus the beam to a spot that can be seen and easily directed onto the vehicle's receiver 8. The vehicle that receives the command accepts the address as its new address, stores it in its internal memory, and thereafter will only respond to commands including that address. When the address is accepted by the vehicle's microprocessor, the vehicle can provide a response such as flashing the vehicle's lights or sounding the vehicle's horn to indicate that the process was successful.

It is desirable that the narrow beam impinge on only one vehicle so that other vehicles do not end up being controlled in parallel, answering the same commands from a single controller. If that should happen, however, it is not a problem in a toy system and will possibly increase enjoyment of the system. One of the features of the present subject matter is a single remote controller's ability to toggle between remote controlled devices. With the push of a button or the flip of a switch (depending on the taste of the controller's manufacturer), the remote controlled device can be made to control the one remote device or the device that was last controlled by the controller.

The microprocessor of both the controller 2 and the vehicle 10 includes a read only memory (ROM) and a random access memory (RAM). It may be an 8 bit microprocessor such as the HE83004 available from Kingbillion. Such a microprocessor may be considered to be standard in the computing industry. However, the programming in the microprocessor and the information stored in the read only memory and the random access memory are individual to this subject matter.

The read only memory stores permanent information and the random access memory stores volatile (or impermanent) information. For example, the read only memory may store the command data to be transmitted when the different buttons 4a-4e in the remote controller 2 are actuated. The random access memory may be used to store timer data for repetition of commands, may store the address, etc.

The controller 2 thereafter sends commands other than the “Hey You” command that include that address preferably over a broad beam of IR modulated light when other buttons 4a-4e are pressed. This allows control of the vehicle without careful aiming of the controller. Commands include turning on motors to drive the vehicle 10 forward, to turn, and to back up. There may be commands to operate other parts of the vehicle 10 such as moving a scoop 14 up and down or operating forklift parts (not shown). Commands to make sounds or raise scoop 16 may also be included. In another version, the horn sound is modified by the programmed address so that different vehicles do not make exactly the same sound.

As an alternative embodiment, commands from the controller 2 may be sent by radio with only the address setting command (referred to alternatively as the “hey you” command) being sent by IR or visible light and all other functions of the vehicle 10 being controlled by radio.

Commands are transmitted using a short burst that is repeated. Good results occur with command bursts of 6-9 milliseconds repeated every 150-250 ms. This allows several controllers to operate at the same time by random bursts without seeming to overlap. The repetition rate should be randomly varied so no two transmitters can get locked transmitting at the same time. Also, to prevent confusion between various controllers, the address sent out during the “hey you” command is a randomly generated eight-bit address so it is unlikely that another vehicle will have this address. The chance of any two vehicles getting the same address using this system is one in 256.

Variations of the “hey you” command transmission include using a narrow beam IR LED modulated with codes including the address and “hey you” command code and using a narrow beam red LED that is on when the “hey you” button is pressed, shining collinearly so that a user sees where the IR LED is directed. Also, the red LED can be used to control the vehicle at closer ranges. To create the narrow beam, a telescope, i.e., a simple convex lens, is added to the optics of the controller. The narrow beam should be about four degrees; however, the narrow beam does not have to be limited to four degrees. The narrow beam can be a narrow laser that does not broaden or that broadens only very little as the beam travels from the controller; or the beam can be very broad (ninety degrees or more) that is made intentionally weak, therefore, a person must get closer to the vehicle when activating the “hey you” function using a broad beam.

To control a vehicle's motions, a much wider beam than the narrow “hey you” command beam is used. There is no risk of the wider beam (roughly thirty to ninety degrees) signaling the wrong vehicle because only the vehicle that received the “hey you” address command will respond to the wide beam commands. As a motion control beam will be much wider than the “hey you” command beam, a user does not have to be as precise with the remote controller when aiming it at a vehicle. If a weak broad beam is used during the “hey you” command, a stronger broader beam can be used to control the vehicle. That way, although a person must get close to the vehicle during the “hey you” address setting operation, a person can stand farther away from the vehicle when controlling the vehicle's actions.

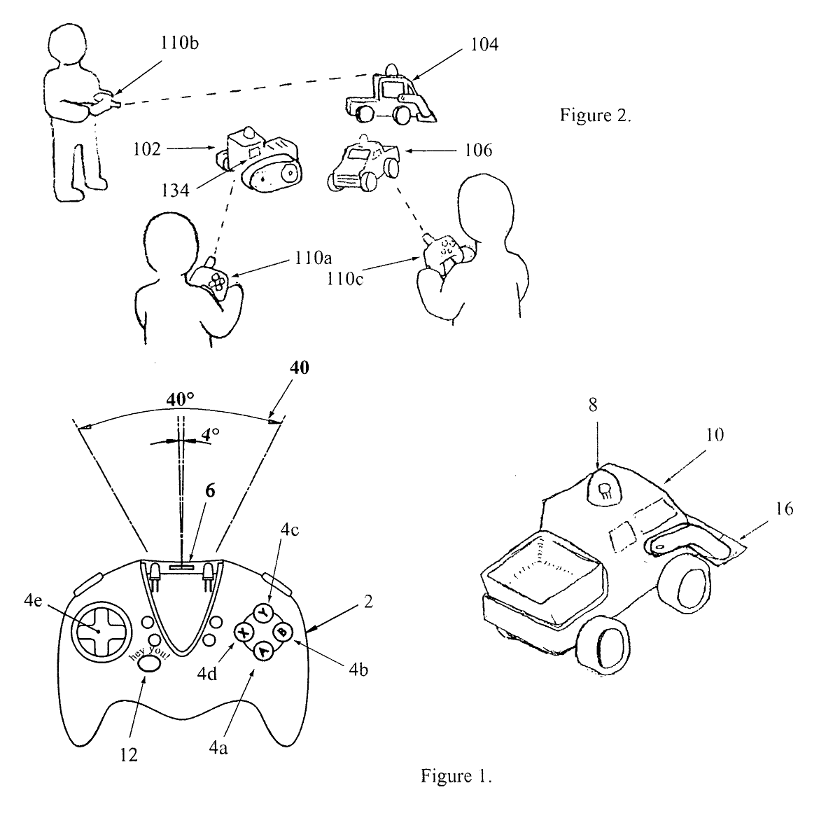

Referring now to FIG. 2, a plurality of remote controllers 110a, 110b and 110c can be used to control each, all or any combination of the vehicles 102, 104 and 106. Transmissions from each of the controllers may be in short packets that will seldom overlap. This transmission causes the selected one of the vehicles 102, 104 and 106 to perform individual one of the individual functions directed by the depression of the different buttons on the individual one of the individual remote controllers. The transmission from each of the controllers to one of the vehicles 102, 104 or 106 can be configured such that multiple commands can be sent at once. For example, the vehicle can be made to drive forward, sound a horn or operate a scoop at the same time.

Every vehicle is always available to be selected by the “Hey You” command from any one of the other remote controllers. Alternatively, a vehicle can be set so that the controller's address is locked into the vehicle until the user releases it. For example, a controller can include a lock command, which would include an instruction requiring the vehicle not to respond to “hey you” commands from other controllers until the vehicle receives a clear command. A “clear” command would be one that has the controller's address and an instruction causing the vehicle to clear its volatile memory of the controller's address thereby allowing the vehicle to respond to a hey you command from any other controller.

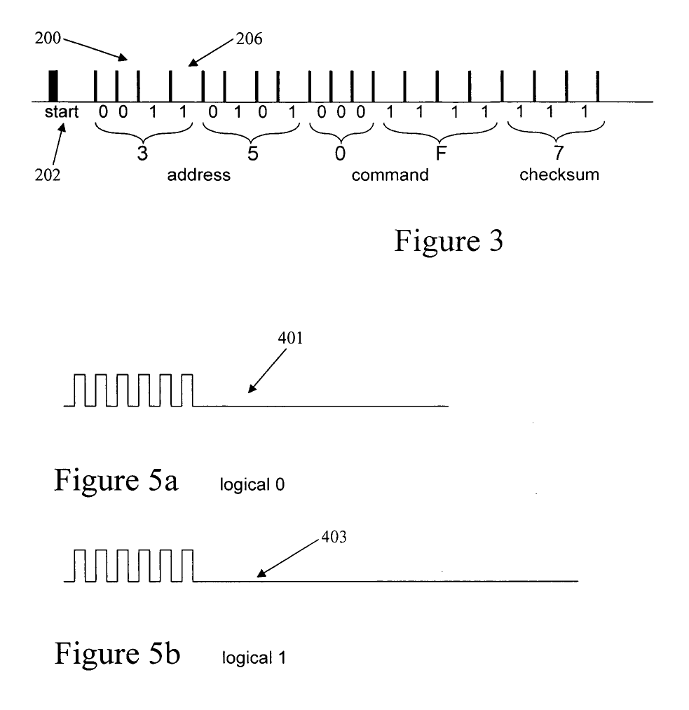

Referring now to FIG. 3, a typical packet or sequence 200 is described. As will be described more fully below, the packet 200 is a sequence of signals in binary form. Each packet 200 of signals includes a start signal 202, different from the 18 data bits that follow. This start signal is used only to establish signal levels in the receiver. Each packet 200 is thus defined by the start signal 202, and includes all of the bits beginning with the start signal 202 and terminating with a stop bit following the eighteenth data bit. A typical command is shown in FIG. 3 representing a hexadecimal address of 35 and the hexadecimal command 0F, —which is 000 1111 in binary. 0F is Hexadecimal or base 16, which may represent the forward full speed command, followed by the nibble-wise checksum of 7. The packets are repeated every 150-200 ms by the modulated optical transmitter 6, shown in FIG. 1. Following the start signal 202 is an eight bit address 206, then 7 bits of binary information that reflect the commands to be generated by buttons 4a-4e on the remote controller 2 then a three bit checksum.

IR LED's are modulated on and off at 56 khz to transmit to a commercial integrated 56 khz IR receiver in the vehicle. Encoding may be the RECS 80 code, which uses pulse length modulation. During testing, a RECS80 code has been used that is on for six cycles, and off for twelve cycles for logical 0, but off for eighteen cycles for logical 1. The start cycle is a unique identifier that is on for twenty cycles, off for ten cycles. The transmission time for a whole command is 6-9 ms at 56 khz. The time is not constant since a logical 1 takes longer to transmit than a logical 0.

In the encoding schemes of the preferred embodiment—the RECS80 code, a binary 0 may be represented by a six pulses of IR at 56 khz followed by a period without pulses equal to 12 cycles of 56 khz. This is illustrated at 401 in FIG. 5a. A binary 1 may be represented by six pulses of IR at 56 khz followed by a period without pulses equal to 18 cycles of 56 khz. This is illustrated at 403 in FIG. 5b. Similarly, the start signal 202 may represent a twelve cycle burst of IR and a pause that is different from any other bit that may be transmitted. Thus, the transmitter 104 may form packets 200 by simply transmitting a repetitive series of IR pulses. Packets are repeated at a rate much less than the packet time, thus giving a sparse transmission. This allows several transmitters to share the same area by random time sharing.

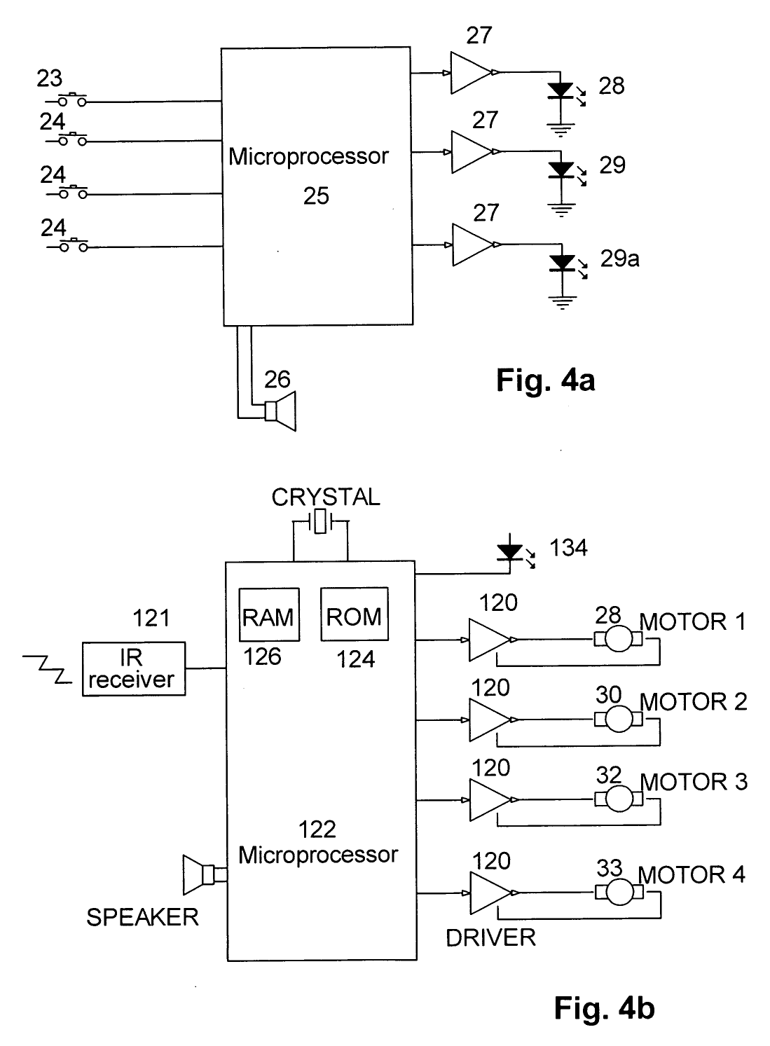

Circuitry for the controller and for the vehicle is shown in block form in FIG. 4. Actuation of hey you button 23 or any combination of buttons 24 provides a signal through microprocessor 25. Microprocessor 25 appends the address of the controller to the signal created by actuation of one or a plurality of the buttons 24. The Microprocessor also determines the nature of the signal and sends the signal through amplifier 27 to an appropriate LED 28, 29 or 29a, wherein in this embodiment LED 28 is a red LED and 29 is a narrow beam IR LED for use with the hey you command and LED 29a is a wide-beam LED for use with other commands. The signal can also cause speaker 26 to sound either in conjunction with actuation of the buttons 24 to provide a “click” or independently to signal changing to the previous vehicle, for instance.

Vehicle 102 includes receiver 121, microprocessor 122 at least one motor 32, speaker 40 and LED 42. The speaker 40 and/or the LED 42 can be used to provide a signal when the vehicle receives a command from the controller.

Circuitry for the vehicle 102 is shown in additional detail in FIG. 4b. Substantially identical arrangements may be provided for the vehicle 104. The vehicle 102 includes a modulated signal (IR) receiver 121 for receiving a signal 69 containing the address of remote controller 110a, 110b or 110c and for conditioning the received signals. The receiver may be a model TSOP34156 available from Vishay. The vehicle 102 also includes motors 28, 30, 32 and 33. Each of the motors 28, 30, 32, and 33 receives signals from an individual one of the integrated or discrete motor drivers 120 connected to a microcontroller generally indicated at 122.

The microcontroller 122 includes a read only memory (ROM) 124 and a random access memory (RAM) 126. The read only memory 124 may store a program to decode the sequence of the successive bits of information in each packet for controlling the operation of the motors 28, 30, 32 and 33 in the vehicle 102. The random access memory 126 provides temporary data storage for the decoded commands, the address, and other variables.

The vehicle 102 may also include a light such as one or more light emitting diodes 134. This diode may be illuminated when the vehicle 102 is operated by one of the remote controllers 110a, 110b and 110c. In this way, the other users can see that the vehicle 102 has been selected by one of the remote controllers 110a, 110b or 110c in case one of the users (other than the one who selected the vehicle 102) wishes to select such vehicle. It will be appreciated that each of the vehicles 102, 104 and 106 may be generally different from the others so each vehicle may be able to perform functions different from the other vehicle. The light emitting diode(s) can be integrated into the design of the vehicle.

When the receiver 121 receives a stream of packets 200 that have been transmitted by the remote controller, the microcontroller 124 decodes each received packet to determine the values of each of the bits included in the packet 200. The value of the address is first compared to the stored address for the vehicle. If it matches, the checksum is then computed to be sure the transmission has not been corrupted by noise. The remaining command bits are then decoded into motor or sound commands or the unique “Hey You” addressing command. When the received packet 200 has been decoded by the microcontroller 122, the microcontroller 122 turns on motors 28, 30, 32 and 33 according to the values of the command bits in the packet 200. The microcontroller may leave the motors on for a period of time equal to a value stored in the read only memory 124 after the command has been received. For example, each motor enabling signal provided by the microcontroller 122 may be continued for 0.4 seconds, unless the microcontroller receives a command from a later received packet 200 to stop the motor enabling signal. One advantage of such a continuation of the enabling signal is that it promotes smooth movement of the vehicle by leaving the motor on until the next motor on command has been transmitted and processed or until a stop signal is received from the controller.

The random access memory 126 in the microcontroller 122 stores the period of time from the last time that the remote controller 110a, for example, issued a command to the vehicle 102. When the period of time in the random access memory 126 equals the preset period, the microcontroller 122 will turn off the motors. The random access memory 126 in the microcontroller 122 also stores the period of time from the last time that the remote controller 2 issued a command to the vehicle 102. This time is used to put the vehicle into a low power “sleep” mode after a period of inactivity. The “Hey You” button 12 in the remote controller 2 does not have to be actuated to issue a command after the remote controller 2 has established a communication link with the vehicle. Any other button pressed will generate commands with the address included in the last “Hey You” command.

The microcontroller 122 in the vehicle continuously monitors the receiver 121 for transmitted packets 200. The microprocessor of each of the vehicles 102 and 104 is responsive to the presence of packets 200. If the receiver 121 of a particular one of the vehicles does not receive a command for a predetermined period of time, the value of which is stored in the read only memory 124, the microcontroller 122 infers that the vehicle is not being used by an operator, and places the vehicle in a low power sleep state which can only be awakened by pressing a vehicle on/off button.

When a vehicle is in the active state and the microcontroller 122 determines that a packet 200 addressed to the particular vehicle has been received and the checksum is correct, it stores the values of the command bits of the packet 200 in the random access memory 126, and executes the command and continues to monitor the output of the receiver 121.

The normal operating environment may contain a high level of random “noise” that may result in extra pulses being received by receiver 121 and sent to the microcontroller 122. Accordingly, the microcontroller may be programmed with the capability of filtering the signals received by the receiver 121 to eliminate spurious packets by verifying a correct number of bits, a match of the address and a checksum, or by other methods.

While not present in the preferred embodiment, another embodiment of the inventive subject matter can be configured such that the microcontroller 122 can cause the light emitting diode 134 to blink continuously while the vehicle is under control of a remotely controlled device and not in a sleep state. Also, in this other embodiment, if the microcontroller 122 determines that the vehicle should be powered down, the microcontroller 122 can provide a visual signal to the operators of the system by causing the light emitting diode 134 to blink at a rate obviously different from the blink rate identifying the powered, but inactive state for a fixed period before the vehicle actually powers down. Of course, the blink rate can be the same as the blink rate identifying the powered but inactive state if so desired. In this example, the light emitting diode may blink at twice the rate for one minute or any other desired amount of time. At the end of the predetermined time, if the microcontroller 122 has still not detected any valid packets, the microcontroller causes the vehicle to be completely powered down, and removes the power from the light emitting diode 134, causing it to go dark.

Further operational optimization may be achieved by using pulse width modulation techniques to energize the motors 28, 30, 32 and 33. For example, the speed of the motors 28, 30, 32 and 33 may be controlled at three different levels by applying power to the motor for part of a power cycle to achieve a first speed, for a greater part of a cycle to achieve a second speed, and continuously throughout the power cycle to achieve a third, maximum speed.

The system and method described above have certain advantages. They provide for the operation of a plurality of vehicles by a plurality of users, either on a competitive or a co-operative basis. Furthermore, the vehicles can be operated on a flexible basis in that a vehicle can be initially selected for operation by one user and can then be selected for operation by another user at any time thereafter. The vehicles being operated at each instant are also visible by the illumination of the LED's 134 on the vehicle.

The system and method of this subject matter are also advantageous in that the vehicles can selectively perform a number of different functions including movements forward and rearward and to the left and the right and including movements of a container or bin or platform on the vehicle upwardly and downwardly or to the left or the right. Different movements can also be provided simultaneously on a coordinated basis.

The system and method of this subject matter are also advantageous in the provision of the remote controllers and the provision of the button and switches in the remote controllers. As will be appreciated, the remote controllers are able to select vehicles and/or stationary accessories through operation of a minimal number of buttons and to provide for the operation of a considerable number of different functions in the vehicles with a minimal number of buttons.

While several forms of the disclosed subject matter have been illustrated and described, it will also be apparent that various modifications can be made without departing from the spirit and scope of the disclosed subject matter. Accordingly, it is not intended that the disclosed subject matter be limited, except by the appended claims.

We claim:

1. A remote control device for causing operation of a function on a remotely controlled device, comprising:
a randomizer for determining a random address for the remote control device;
a first mechanical actuator configured to cause a first modulated optical transmitter to emit a signal that contains said random address, wherein reception of said random local address by the remotely controlled device establishes a communication link between the remote control device and the remotely controlled device; and
a plurality of mechanical actuators configured to create a plurality of signals, wherein said one of a plurality of signals is transmitted to the remotely controlled device to dictate action of the remotely controlled device
wherein said first modulated optical transmitter emits a narrow beam.

2. The device of claim 1, further comprising a toggle actuator for toggling between a first and a second remote controlled device wherein said toggle actuator is configured to cause the emission of a first or a second random local address to at least two of a plurality of different remote controlled devices.

3. The device of claim 2 wherein said modulated optical transmitter is capable of simultaneously dictating a same function for said at least two of the plurality of different remotely controlled devices.

4. The device of claim 1 further comprising a plurality of mechanical actuators configured to create a plurality of signals, wherein said one of a plurality of signals is a signal that is transmitted through a second modulated transmitter to the remotely controlled device to dictate action for the remotely controlled device

5. The device of claim 4, further comprising a microprocessor configured such that said at least one of a plurality of signals includes said random address.

6. The device of claim 5 wherein said microprocessor is configured to prevent control of said at least one of a plurality of remotely controlled devices by a second remote control device.

7. The device of claim 1, wherein transmission time for a signal is no more than one tenth of a repeat period.

8. The device of claim 1 further comprising a second optical transmitter for emitting a red light collinearly with said signal that contains said random address.

9. The device of claim 8 wherein said signal that contains said random address is an infrared signal.

10. A method for causing operation of a function of a remotely controlled device, comprising:
pointing a remote device in a direction of the remotely controlled device,
actuating an actuator on said remote device, thereby causing said remote device to send a remote device address signal to a signal receiver on the remotely controlled device; and
actuating a second actuator on the remote control device thereby causing the device to send a selected encoded signal including said address from an infrared signal emitter on said remote device so as to dictate actions of said remotely controlled device.

11. The method of claim 10, further comprising toggling between control of said first remotely controlled device and control of a second remotely controlled device by using a first address for said first remotely controlled device and a second address for said second remotely controlled device.

12. The method of claim 10, further comprising using said remote device to simultaneously dictate a same function for both said remotely controlled device and for a second remotely controlled device.

13. The method of claim 11, wherein transmission time for a signal is no more than one tenth of a repeat period.

14. The method of claim 10 further comprising preventing control of said remotely controlled device by a second remote device.

15. The method of claim 10 further comprising emitting a red light collinearly with said remote device address signal.

16. The method of claim 15 wherein said remote device address signal is an infrared signal.

17. The method of claim 10 where the second actuator sends a radio signal.
